(19) United States
(12) Patent Application Publication
(10) Pub. No.: US 2017/0046662 A1
(43) Pub. Date: Feb. 16, 2017

(54) WARRANTIED COMPONENT COST OPTIMIZATION

(71) Applicant: International Business Machines Corporation, Armonk, NY (US)

(72) Inventors: Robert G. Atkins, Poughkeepsie, NY (US); Francis X. Scanzano, Newburgh, NY (US); Kyle Wonderly, Beacon, NY (US)

(21) Appl. No.: 14/821,852

(22) Filed: Aug. 10, 2015

(51) Int. Cl. G06Q 10/00

(52) U.S. Cl. CPC G06Q 10/20

(57) ABSTRACT

A method of managing a component manufacturer warranty information is provided. The method may include collecting vital product data (VPD) of an array of components in a server into a database, where the VPD includes at least one of a component manufacturer name, a component manufacturer part number, a component serial number, a component firmware level, a component manufacturer warranty length, a warranty begin date, a warranty end date, a component replacement cost, monitoring the array of components for a failing component, confirming the failing component is covered under the component manufacturer warranty, determining a cost effectiveness for a repair action and a delay repair action, and initiating a service call based on the determined cost effectiveness.

### BACKGROUND

The present disclosure relates generally to a computer system/server and component manufacturer warranties.

The present disclosure relates generally to a computer system/server and the use of redundancy. Redundancy is the inclusion of an extra component which is not strictly necessary for functioning of the computer system/server. The extra component can be used in the case of a failure of a component. This may be referred to as fail in place architecture. The component which has failed may be covered by a component manufacturer warranty which has a time limit. It may be advantageous to replace a failed component prior to the expiration of a component manufacturer warranty. Replacing a failed component while under the component manufacturer warranty may be referred to as optimizing the component manufacturer warranty. The types of components which may have redundancy may include microprocessors, memory, switch chips, ASICs, flash memory, hard drives, solid state drives, fans and power supplies, among other devices. An improved method of component manufacturer warranty management can provide cost savings by replacing failing electronic components during the manufacturer warranty period and optimizing cost savings

### SUMMARY

According to one embodiment of the present invention, a method of managing a component manufacturer warranty information is provided. The method may include collecting vital product data (VPD) of an array of components in a server into a database, where the VPD includes at least one of a component manufacturer name, a component manufacturer part number, a component serial number, a component firmware level, a component manufacturer warranty length, a warranty begin date, a warranty end date, a component replacement cost, monitoring the array of components for a failing component, confirming the failing component is covered under the component manufacturer warranty, determining a cost effectiveness for a repair action and a delay repair action, and initiating a service call based on the determined cost effectiveness.

According to another embodiment, a computer program product for managing a component manufacturer warranty information is provided. The computer program product includes one or more computer-readable storage media and program instructions stored on the one or more computer-readable storage media, the program instructions includes program instructions to collect vital product data (VPD) of an array of components in a server into a database, wherein the VPD includes at least one of a component manufacturer name, a component manufacturer part number, a component serial number, a component firmware level, a component manufacturer warranty length, a warranty begin date, a warranty end date, a component replacement cost, program instructions to monitor the array of components for a failing component, program instructions to confirm the failing component is covered under the component manufacturer warranty, program instructions to determine a cost effectiveness for a repair action and program instructions to delay a repair action, and program instructions to initiate a service call based on the determined cost effectiveness.

According to another embodiment, a computer system for managing a component manufacturer warranty information is provided. The computer system includes one or more computer processors, one or more computer-readable storage media, and program instructions stored on one or more of the computer-readable storage media for execution by at least one of the one or more processors, the program instructions includes program instructions to collect vital product data (VPD) of an array of components in a server into a database, wherein the VPD includes at least one of a component manufacturer name, a component manufacturer part number, a component serial number, a component firmware level, a component manufacturer warranty length, a warranty begin date, a warranty end date, a component replacement cost, program instructions to monitor the array of components for a failing component, program instructions to confirm the failing component is covered under the component manufacturer warranty, program instructions to determine a cost effectiveness for a repair action and program instructions to delay a repair action, and program instructions to initiate a service call based on the determined cost effectiveness.

### BRIEF DESCRIPTION OF THE DRAWINGS

For a more complete understanding of this disclosure, reference is now made to the following brief description, taken in conjunction with the accompanying drawings and detailed description, wherein like reference numerals represent like parts.

FIG. 1 illustrates an exemplary computing node operable for various embodiments of the disclosure.

FIG. 2 is an operational flowchart illustrating an algorithm for creating a method of managing a component device warranty information, according to various embodiments of the disclosure.

FIG. 3 is a schematic block diagram of hardware and software of the computer environment according to an embodiment of the processes of FIG. 2.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

The present disclosure relates generally to a computer system/server and the use of redundancy, or the inclusion of an extra component which is not strictly necessary for functioning of the computer system/server. The extra or spare component can be used in the case of a failure of a component. This may be referred to as fail in place architecture. The component which has failed may be covered by a component manufacturer warranty which has a time limit. It may be advantageous to replace a failed component prior to the component manufacturer warranty time limit. The types of components which may have redundancy may include microprocessors, memory, switch chips, ASICs, flash memory, hard drives, solid state drives, fans and power supplies, among other devices. An improved method of component manufacturer warranty management can provide cost savings by replacing failing electronic components during the manufacturer warranty period.

A computer datacenter is a facility which houses one or more computer systems, as described below, and related components, such as storage systems, telecommunication equipment, fans, air conditioning and power supplies. Modern architectures for large datacenters or computer datacenters can include a provision for certain electronic components, or components, to fail in place. Spare capacity or redundant components may be shipped with an initial computer system installation, such that if a component fails, the component may stay failed in place while the overall computer system performance criteria is maintained. This offers significant advantages to service cost and system availability because the spare component takes over, maintaining component availability, and this reduces service costs by reducing the number of service calls to the datacenter. A group of the same components may be referred to as an array. The array may be a Field Replaceable Unit (FRU), which is an assembly, circuit board, or part which can be removed from the computer server and can be replaced by a system services representative, or SSR, from the service vendor. The computer datacenter may have at least one of a computer datacenter manager and a service vendor which is responsible for some or all of the maintenance of the computer datacenter.

The array of components may have spare capacity and may be designed to maintain system performance requirements when a component in the array has failed. Traditionally, the array may not be serviced until a specific number of components in the array has failed. This may result in components failing during a component manufacturer warranty, or warranty, and being replaced after an expiration of the warranty. The component manufacturer may replace the failing component, or provide credit, during the warranty period. An agreement or service contract between the computer datacenter and the service vendor may identify which party is responsible for maintenance of the computer datacenter and replacement of failing components. Depending on the agreement, the computer datacenter or the service vendor will have an expense to replace the failed component. The component may be a microprocessor, a memory component, an ASIC component, storage devices, power supplies, data communications connections, environmental controls, and other devices. The computer datacenter or a service vendor may spend money unnecessarily on a replacement component if the failed component fails during the warranty period and is replaced after the expiration of the warranty.

A system administrator may manage a configuration and an operation of logical partitions in the computer system, as well as monitor the computer system for hardware problems. A computer system can be partitioned into multiple logical partitions. A logical partition or LPAR, is a subject of a computer system's hardware resources which is virtualized as a separate computer. A LPAR can host a separate operating system, for example UNIX, z/OS, Linux, AIX and other operating systems. Computer hardware virtualization hides physical characteristics of a computer system from the users and instead shows an abstract computing interface. The system administrator may perform these tasks using a console. The console may have network connections to one or more computer systems and perform management functions of the computer systems. The console may create a service call under certain conditions, for example a pre-determined number of failures in an array may trigger a service call. The service call may be programmed to send an email message to at least one of the computer datacenter manager and the service vendor, and may include information regarding what has triggered or initiated the service call. As a result of the service call, a system services representative, or SSR, from the service vendor may repair or replace components in the computer system. The SSR may travel to the computer datacenter. The cost of the service call may be negotiated between the computer datacenter and the service vendor and may be part of the service contract between these two parties. The cost of the service call may include a fixed cost plus a cost of any replacement components which have failed.

The terms of the component manufacturer warranty may be negotiated between the component manufacturer, the computer datacenter and/or the service vendor. The terms of the warranty may define a warranty length, a warranty begin date and a warranty end date. The warranty may have the warranty length measured by a defined amount of months or years, or the warranty length measured by the number of power on hours which the component has power applied to it while in the computer system. For a warranty length with a defined amount of months or years, the warranty begin date may be the date of the component purchase, the date of the component shipment, the date of the component delivery, the date of the component installation, or another date. The warranty end date may be defined by the length of the warranty measured, for example thirty six months. For a warranty defined by the number of power on hours, the warranty end date may be defined at the end of the warranty number of hours, for example 10,000 power on hours. The warranty length, the warranty begin date and the warranty end date may be specific to the component manufacturer, the type of component or the commodity of the component.

An example of an array of components utilizing fail in place architecture is a hard disk drive in a high availability software RAID (redundant array of independent disks), such as a disk drive declustered array with forty or more disk drives. In this instance the disk drive declustered array may have more than five failures of individual disk drives before there is a risk of loss of data. A fail in place strategy for the disk drive declustered array may be to not replace a first disk drive that fails within the declustered array, but to wait until a second disk drive fails in the declustered array, and then to replace both the first disk drive and the second disk drive. The fail in place strategy may reduce the number of service calls to the computer datacenter, and may allow for the declustered array in the data center to not have any service calls for a long period of time. In this case, there would be one service call to replace both the first disk drive and the second disk drive, instead of two individual service calls to replace one disk drive at a time. The fail in place strategy may have a disadvantage that the first hard drive to fail may have been eligible for a warranty replacement by the disk drive manufacturer, but the component manufacturer warranty may expire before the second failure disk drive occurs. This may result in the loss of a component manufacturer replacement for the first disk drive which failed, with unnecessary cost to the computer datacenter or the service vendor. Thus, an improved method of component manufacturer warranty management may provide cost savings by replacing failing electronic components during the manufacturer warranty period.

The system administrator may use a standard interface for configuring and operating partitioned systems in the computer system, for example a Hardware Management Console (HMC). The standard interface may be referred to as a control point or a hardware focal point. The control point may be able to manage the software configuration and operation of the computer system/servers and the operation of the partitions in the computer datacenter, as well as monitor and identify hardware problems. The control point may detect an error in a component which was previously defined to the control point and may perform failure analysis to identify the failing components. An example of a detected error may be that the same component is getting multiple soft fails, which are correctible errors. The error may be correctible via redundancy as described above. As a result of the detected error, the control point may perform at least one of the following: create a log entry, notify the computer datacenter manager, notify the service vendor, notify the component supplier of a failing component and trigger the service call. The control point can consolidate the log entries from various operating systems.

In an embodiment, a method of identifying the warranty end date for a failing component can be used to trigger a service call, to the computer datacenter and for replacement of the failing component before the manufacturer warranty is expired. For example, for a hard drive failure, a service call can be generated to the server service provider to invoke a SCSI Enclosure Services (SES) command. For other electronic components under a component manufacturer warranty, in band or out of band paths would be appropriate to determine their age.

In an embodiment, the standard interface may monitor metadata associated with a component. The metadata may include a make, model and date of manufacture of a fail in place component, and to store a manufacturer warranty information, such as warranty length, warranty start and warranty end dates. If a component is under a manufacturer warranty and fails, the component can be replaced, or a credit issued by the component manufacturer. This may save a computer datacenter service organization an amount of revenue which was previously lost due to the fail in place architecture which may inadvertently delay component replacement past the manufacturer warranty end date.

A cost effectiveness may be evaluated to determine whether or not to trigger a service call or to delay a repair action. The cost effectives may take into account a minimum threshold service call cost, which may include work performed by the SSM, travel, an accumulated cost of any failing components to be replaced, an amount of time left on the failing component manufacturer warranties, any maintenance work required in the computer datacenter, and other considerations. The cost of the service call may be compared to a cost of the replacement components which would be covered by the component manufacturer warrantee. The cost effectiveness to delay the repair action or service call based on the amount of time left on the component manufacturer warranty for the failing component

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”, “module”, or “system”. Furthermore, aspects of the present invention may take the form of a computer program product embodied in one or more computer readable medium(s) having computer readable program code embodied thereon.

Aspects of the present disclosure are described below with reference to flowchart illustrations and/or block diagrams of methods, apparatus, (systems), and computer program products according to embodiments of the invention. It will be understood that each block of the flowchart illustrations and/or block diagrams, and combinations of blocks in the flowchart illustrations and/or block diagrams, can be implemented by computer program instructions.

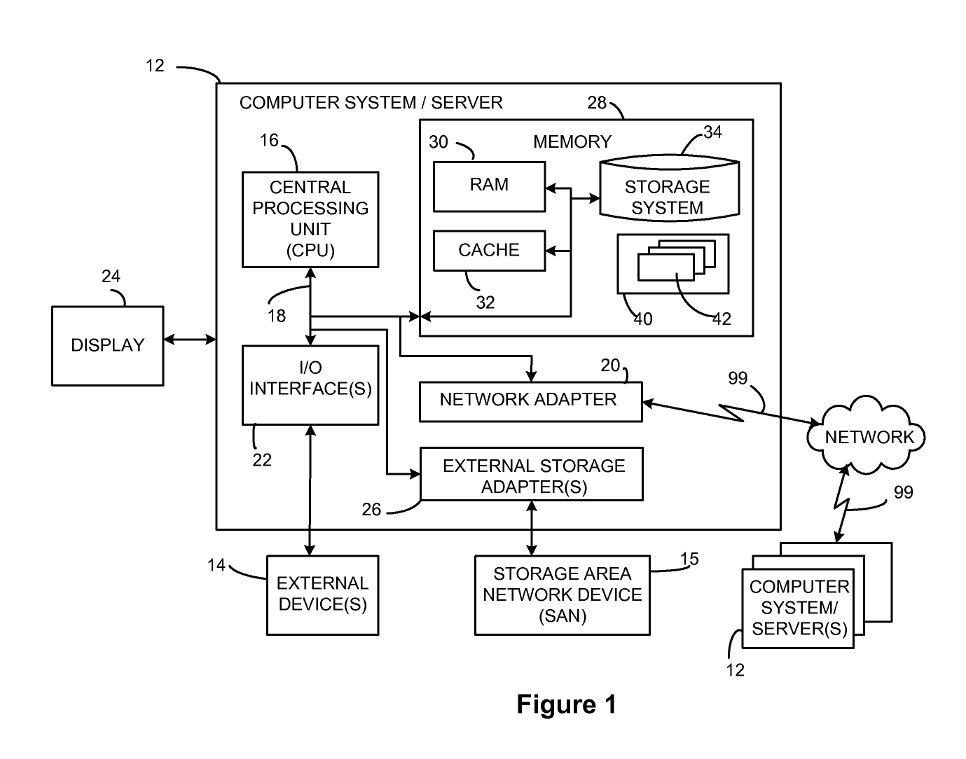

A method of managing component warrantees is described in detail below by referring to the accompanying drawings in FIGS. 1 to 4, in accordance with an illustrative embodiment.

Turning now to FIG. 1, a block diagram of an exemplary computer system (i.e., server) 12 operable for various embodiments of the disclosure is presented. As shown, the server 12 is an example of a computer system. The server 12 is a suitable computer for creating warranted component cost optimization and is not intended to suggest any limitation as to the scope of use or functionality of embodiments of the disclosure described herein.

The server 12 is operational in numerous other computing system environments or configurations. For example, the server 12 may be a standalone machine, a virtual partition on physical host, a clustered server environment, or a distributed cloud computing environment that include any of the above systems or devices, and the like. When practiced in a distributed cloud computing environment, tasks may be performed by both local and remote servers 12 that are linked together and communicate through a communications network, such as the network 99.

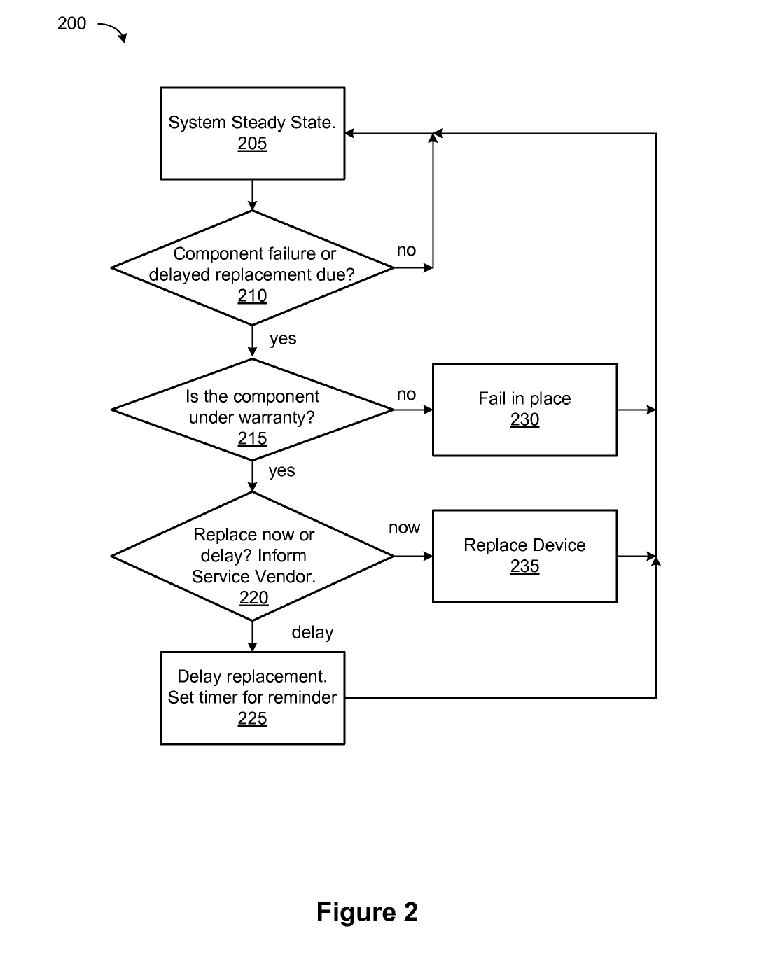

The server 12 may be described in the context of executable instructions, such as a program, or more specifically, an operating system (OS) 40 that is an aggregate of program modules 42 being executed by the central processing unit (CPU) 16 to control the operation of the server 12. The program modules 42 may perform particular tasks of the OS 40, such as process management; memory management; and device management. The program modules 42 may be implemented as routines, programs, objects, components, logic, or data structures, for example. The program modules 42 performing the particular tasks may be grouped by function, according to the server 12 component that the program modules 42 control. At least a portion of the program modules 42 may be specialized to execute the algorithm of FIG. 2.

In a distributed computing environment, such as a cloud computing environment, each participating server 12 may be under the control of an OS 40 residing on each local and remote server 12, respectively. In a virtual machine, also referred to as a virtual server, each instance of the virtual machine is an emulation of a physical computer. A physical computer may host multiple virtual machine instances, each sharing the hardware resources of the physical computer, and each emulating a physical computer. Each of the virtual machine instances is under the control of an OS 40.

The components of the server 12 may include, but are not limited to, one or more CPUs 16, a system memory 28, and a bus 18 that couples various system components, such as the system memory 28 and the CPU 16.

The system memory 28 can include computer system readable media in the form of volatile memory, such as random access memory (RAM) 30 and/or cache memory 32. The server 12 may further include other removable/non-removable, volatile/non-volatile computer system storage media.

By way of example only, a storage system 34 can be provided as one or more components or devices for reading from and writing to a non-removable, non-volatile magnetic media, such as a hard disk drive (HDD) or an optical disk drive such as a CD-ROM, DVD-ROM. Each device of the storage system 34 can be connected to bus 18 by one or more data media interfaces. The program modules 42, the OS 40, and one or more application programs may be stored on the storage system 34 and subsequently loaded into system memory 28 for execution, as needed.

The server 12 may also communicate with one or more external devices 14 such as a keyboard, a pointing device, a display 24, etc.; one or more devices that enable a user to interact with the server 12; and/or any devices (e.g., network card, modem, etc.) that enable the server 12 to communicate with one or more other computing devices. Such communication can occur via I/O interfaces 22.

The server 12 can communicate with one or more networks such as a local area network (LAN), a general wide area network (WAN), and/or a public network (e.g., the Internet) via a network adapter 20. As depicted, the network adapter 20 communicates with the other components of the server 12 via bus 18. However, in a multi-tenant datacenter (MTD) environment, such as a cloud computing environment, network communications may be routed through member servers 12 and virtual machines through both physical devices (e.g., network adapters network switches), and virtualized networks, such as those implemented using software defined networking (SDN).

The external storage adapter 26 connects the server 12 with external storage subsystems, such as a storage area network (SAN) 15 or RAID array. Exemplary external storage adapters 26 include, but are not limited to, a host bus adapter (HBA), host channel adapter (HCA), SCSI, and iSCSI, depending upon the architectural implementation. The external storage adapter 26 communicates with the CPU 16 and the system memory 28 of the server 12 over the bus 18.

It should be understood that although not shown, other hardware and/or software components could be used in conjunction with the server 12. Examples include, but are not limited to: microcode, device drivers, redundant processing units, external disk drive arrays, RAID systems, tape drives, and data archival storage systems, etc.

Referring now to FIG. 2, an algorithm 200 for creating a method of managing a component device warranty information, according to various embodiments of the disclosure is illustrated. At 205, the server 12 (FIG. 1) is at a system steady state. Following is a description of the system steady state.

During an initial installation of the server 12, at power on, a system test may be performed by the HMC. The HMC may contact the firmware on the server to interrogate the installed components. The components each respond to the HMC with an individual component status. The system test may include testing of the server 12 and the components of the server 12, the OS 40 and the HMC. Following a successful system test, the computer server may go into production and the computer server and the HMC have reached a system steady state. During the system steady state, the HMC may be self-monitoring and keep track of the removal and the addition of the components of the server 12.

Non-volatile memory may be stored in an array and may have information populated by at least one of the component manufacturer, the system administrator and another party. The information may be referred to as Vital Product Data (VPD). The VPD may include information regarding the component, such as a component manufacturer name, a component manufacturer part number, a component serial number and a component firmware level. The VPD may include the warranty information, such as whether the warranty length is a defined number of months or years, or if the warranty length is measured by the number of power on hours. The VPD may also include the warranty begin date and the warranty end date. For example, an array may have information in the non-volatile memory indicating the warranty length is a defined amount of 36 months, and the warranty begins at the component purchase date. At system test, the standard interface may query the arrays for the warranty information and collect or store the warranty information in a database, including the location of the component in the server 12. The database may be updated with received information regarding the warranty begin date, for an example of an array with a warranty that begins on the purchase date of Jan. 1, 2015. The warranty begin date may be populated into the non-volatile area of the array by the component manufacturer, or the HMC may also update this information directly into the array it pertains to. The database may be stored in the server 12, for example the system memory 28 or in an external database repository. The standard interface may keep track of VPD information and the location and the warranty information as an array is added or removed from the computer server, and update any applicable database including the non-volatile memory of the array. In an embodiment, the algorithm 200 may be run at least of one the CPU 16, a centralized workstation in the computer datacenter and an external machine.

At 210 the algorithm 200 may be monitoring the components of the server 12 for a notification that a component has failed, or that a delayed replacement timer has expired, as described below. The HMC receives the notification that a fail in place has occurred which may come from the system memory 28, the storage system 34, the RAM 30, the cache memory 32 or any of the other components of the server 12 which have redundancy, as shown in FIG. 1. At 210 if there is not a notification that a first component of the server 12 has failed, the server 12 remains at the system steady state 205. At 210 if there is a notification that a component of the server 12 has failed, then the algorithm 200 continues to 215.

At 215, the algorithm 200 will query the database for the warranty information of the component that has failed. If the component that has failed is not replaceable by a component manufacturer warranty, then the algorithm 200 moves to 230 which is to have the component fail in place. As described previously, fail in place is the inclusion of an extra component can be used in the case of a failure of a component. The algorithm 200 then returns to 205 system steady state. Information on the component that has failed is logged in a failure log in the database. If the component that has failed is replaceable by a component manufacturer warranty then the algorithm 200 continues to 220.

At 220, there is a decision to replace the component that has failed, plus any previously logged component that had failed, at the current time or to delay the service call to replace these components. The determined cost effectiveness is established by a pre-existing set of conditions, such as the cost of the failing components, evaluating the amount of time left on the warranty of each failing component and the service call cost. The replacement cost of the failing components may be in the database and stored and updated by the HMC. Maintenance of the replacement cost may be performed by receiving, or configurable by the system administrator, into the HMC periodic updated replacement cost information. The decision to delay a service call and replace the component that has failed may also be made if there is more than a fixed amount of time left in the component manufacturer's warranty. For example, there may be a policy such that if there is greater than six months left on the warranty, then the service call may be delayed. Information on the failing component is logged in a failure log in the database, and the HMC may send a notification of the failure via email messages to both the system administrator and the service vendor. The email message may include information regarding the VPD of the component which has failed, the failure date, the replacement cost, the amount of time left in the component manufacturers warranty, and the decision of whether to replace the component now or to delay the service call. The email message may include this specified information for all unprocessed components which have failed and are logged in the database. Once a component which has failed is replaced, the component which has failed has been processed. Thus, the system administrator and the service vendor may have the option to override the decision to replace now or delay.

At 225, if the decision is to delay replacement of the failing components then a timer will be set for configurable amount of time to delay the replacement of the component which has failed. The timer will be set for a pre-determined amount of time, to trigger the algorithm 200 to reevaluate the need for a service call via algorithm 200. For example, the timer may be set for 2 months and the end of the timer period is 2 months after the component failure has been logged in the database. After 225, the algorithm 200 will return to system steady state 205.

At 225, if the decision is to replace the failing component, then at 235, the algorithm 200 will initiate a service call to the datacenter to replace the component which has failed. After the components which have failed have been replaced, the algorithm 200 continues to 205 where the server 12 may return to the system steady.

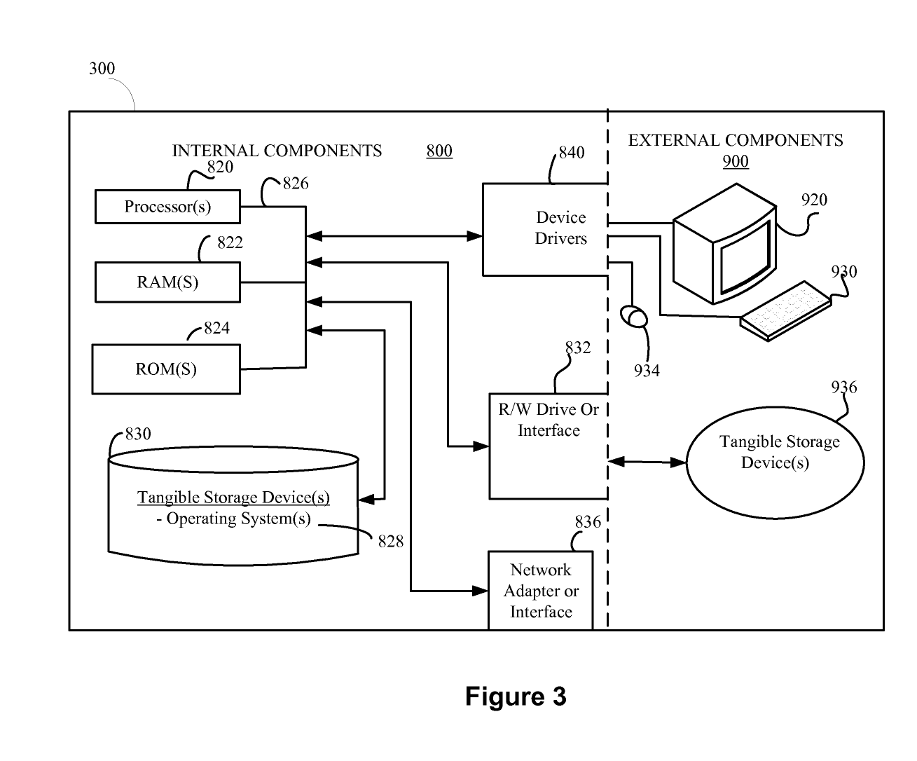

Referring now to FIG. 3, computing device 300 may include respective sets of internal components 800 and external components 900 that together may provide an environment for a software application. Each of the sets of internal components 800 includes one or more processors 820; one or more computer-readable RAMs 822; one or more computer-readable ROMs 824 on one or more buses 826; one or more operating systems 828 executing the method of FIG. 2; and one or more computer-readable tangible storage devices 830. The one or more operating systems 828 (including the additional data collection facility) are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 also includes a R/W drive or interface 832 to read from and write to one or more computer-readable tangible storage devices 936 such as a CD-ROM, DVD, SSD, memory stick, magnetic tape, magnetic disk, optical disk or semiconductor storage device.

Each set of internal components 800 may also include network adapters (or switch port cards) or interfaces 836 such as a TCP/IP adapter cards, wireless WI-FI interface cards, or 3G or 4G wireless interface cards or other wired or wireless communication links. The operating system 828 that is associated with computing device 300, can be downloaded to computing device 300 from an external computer (e.g., server) via a network (for example, the Internet, a local area network, or other wide area network) and respective network adapters or interfaces 836. From the network adapters (or switch port adapters) or interfaces 836 and operating system 828 associated with computing device 300 are loaded into the respective hard drive 830 and network adapter 836. The network may comprise copper wires, optical fibers, wireless transmission, routers, firewalls, switches, gateway computers and/or edge servers.

Each of the sets of external components 900 can include a computer display monitor 920, a keyboard 930, and a computer mouse 934. External components 900 can also include touch screens, virtual keyboards, touch pads, pointing devices, and other human interface devices. Each of the sets of internal components 800 also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Various embodiments of the invention may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although preferred embodiments have been depicted and described in detail herein, it will be apparent to those skilled in the relevant art that various modifications, additions, substitutions and the like can be made without departing from the spirit of the disclosure, and these are, therefore, considered to be within the scope of the disclosure, as defined in the following claims.

Warranty management presents an opportunity to manage costs of maintenance of a server or computer datacenter. By replacing failing components in a timely manner within a component manufacturer warranty period, a service provider of the computer datacenter may avoid later expenditures when the amount of failing components in an array exceeds the maximum allowable number of failing components in the array. This may allow the computer datacenter to continue to meet speed and service objectives while maintaining the fail in place architecture. Fail in place is also referred to as FTP.

It may be noted that not all advantages of the present invention are include above.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A method of managing a component manufacturer warranty information comprising:
collecting vital product data (VPD) of an array of components in a server into a database, wherein the VPD comprises at least one of a component manufacturer name, a component manufacturer part number, a component serial number, a component firmware level, a component manufacturer warranty length, a warranty begin date, a warranty end date, a component replacement cost, wherein the array of components is arranged in a fail in place architecture;
creating log entries in a failure log, wherein each log entry comprises the VPD of a failed component of the array of components;
determining a first set of components from the log entries in the failure log, wherein the warrantee end date of each component of the first set of components is before a current date;
determining a repair action cost, wherein the repair action cost comprises a service call cost and a summation of each of the component replacement costs of each of the components in the first set of components;
determining a second set of components from the log entries in the failure log, wherein the warrantee end date of each component of the second set of components is before thirty days after the current date;
determining a delay repair action cost, wherein the delay repair action cost comprises a service call cost and a summation of each of the component replacement costs of the each of the components in the second set of components;
overriding a fail in place service call hold, wherein the fail in place service call hold delays a service call until a pre-determined number of components of the array of components has failed; and
initiating a service call to replace all failed components identified in the failure log based on the delay repair action cost being greater than the repair action cost and the number of failed components identified in the failure log being less than the pre-determined number of components.

2. The method of claim 1, wherein initiating the service call further comprises:
creating a log entry in a service log, wherein the log entry in the service log comprises the VPDs of each failed component in the failure log; and
notifying at least one of a computer datacenter manager and a service vendor, wherein the notification includes the VPDs of each failing component in the failure log.

3. The method of claim 1, wherein determining the first set of components comprises:
comparing a failure date of each of the failed components in the failure log to the corresponding warranty end date; and
determining if each of the failed components is under the corresponding component manufacturer warranty.

4. The method of claim 1, wherein determining a cost effectiveness for the repair action cost and the delay repair action cost further comprises:
storing a minimum threshold service call cost; and
evaluating an amount of time left on each of the failed components corresponding manufacturer warranty.

5. The method of claim 1, wherein determining a cost effectiveness for the repair action cost and the delay repair cost action further comprises:
determining a composite cost effectiveness for a repair action for each log entry in the failure log;
storing a minimum threshold service call cost; and
evaluating an amount of time left on the component manufacturer warranty for each of the failed components.

6. The method of claim 1, wherein the delay repair action cost further comprises setting a configurable timer period to reevaluate a cost effectiveness for the repair action cost at the end of the timer period.

7. The method of claim 1, wherein the method is run on at least one of a server, a centralized workstation, a computer datacenter, and an external machine.

8-20. (canceled)

21. A method of optimizing failing component replacement scheduling comprising: collecting vital product data (VPD) of each component in an array of components in a server into a database, wherein the VPD comprises at least one of a component manufacturer name, a component manufacturer part number, a component serial number, a component firmware level, a component manufacturer warranty length, a warranty begin date, a warranty end date, a component replacement cost, wherein the array of components is arranged in a fail in place architecture;
creating log entries in a failure log, wherein each log entry comprises the VPD of a failed component of the array of components;
determining a first set of components from the log entries in the failure log, wherein the warrantee end date of each component of the first set of components is before a current date;
determining a repair action cost, wherein the repair action cost comprises a service call cost and a summation of each of the component replacement costs of each of the components in the first set of components;
determining a second set of components from the log entries in the failure log, wherein the warrantee end date of each component of the second set of components is before thirty days after the current date;
determining a delay repair action cost, wherein the delay repair action cost comprises a service call cost and a summation of each of the component replacement costs of the each of the components in the second set of components;
overriding a fail in place service call hold, wherein the fail in place service call hold delays a service call until a pre-determined number of components of the array of components has failed; and
postponing a service call based on the delay repair action cost being equal to the repair action cost.

22. The method of claim 21, wherein initiating the service call further comprises:
creating a log entry in a service log, wherein the log entry in the service log comprises the VPDs of each failed component in the failure log; and
notifying at least one of a computer datacenter manager and a service vendor, wherein the notification includes the VPDs of each failed component in the failure log.

23. The method of claim 21, wherein determining the first set of components comprises:
comparing a failure date of each of the failed components in the failure log to the corresponding warranty end date; and
determining if each of the failed components is under the corresponding component manufacturer warranty.

24. The method of claim 21, wherein determining a cost effectiveness for the repair action cost and the delay repair action cost further comprises:
storing a minimum threshold service call cost; and
evaluating an amount of time left on each of the failed components corresponding manufacturer warranty.

25. The method of claim 21, wherein determining a cost effectiveness for the repair action cost and the delay repair cost action further comprises:
determining a composite cost effectiveness for a repair action for each log entry in the failure log;
storing a minimum threshold service call cost; and
evaluating an amount of time left on the component manufacturer warranty for each failed component.

26. The method of claim 21, wherein the delay repair action cost further comprises setting a configurable timer period to reevaluate a cost effectiveness for the repair action cost at the end of the timer period.

27. The method of claim 21, wherein the method is run on at least one of a server, a centralized workstation, a computer datacenter, and an external machine.
